(19) United States
(12) Patent Application Publication
(10) Pub. No.: US 2001/0029612 A1
(43) Pub. Date: Oct. 11, 2001

(54) Network system for image data

(75) Inventor: Stephane Harnois, Laval (CA)

Correspondence Address: GATES & COOPER LLP, HOWARD HUGHES CENTER, 6701 CENTER DRIVE WEST, SUITE 1050, LOS ANGELES, CA, 90045, US

(73) Assignee: Discreet Logic Inc.

(21) Appl. No.: 09/738,478

(22) Filed: Dec. 15, 2000

(30) Foreign Application Priority Data
Apr. 6, 2000 (GB) 0008318.8

(51) Int. Cl. H04N 7/173

(52) U.S. Cl. 725/86

(57) ABSTRACT

A networked image processing environment has several image data processing systems (501-508). In addition, there are provided many storage systems (511-518) in which each of the data storage systems is operated under the direct control of one of the image processing systems. A fiber channel switch (521) is connected to each of the data processing systems and to each of the storage systems. A low bandwidth Ethernet (551) connects the image processing systems together and is also connected to the fiber channel switch. Under this arrangement, the fiber channel switch is controlled by one of the processing systems. A first processing system requests access to a data storage system controlled by a second processing system over the Ethernet. The second processing system makes an identification of storage regions that may be accessed by the first processing system then conveys this identification to the first processing system, again over the Ethernet. Having received this information, the first processing system accesses the identified storage portion but this time via the high bandwidth switching means. This provides a stable environment which allows host processors to gain access at full bandwidth to storage systems controlled by other hosts processors.

### BACKGROUND OF THE INVENTION

1. Field of the Invention

The present invention relates to a network system for image data processing systems, in which image data is shared between a plurality of image processing systems.

2. Description of the Related Art

Networks for image data processing systems are known that use standard distribution protocols, such Ethernet, TCP/IP and HiPPI. In video facilities houses, video data is often conveyed between machines using digital video tape or similar magnetic storage media. This provides a relatively inexpensive way of conveying data between stations and is beneficial particularly when image data is to be archived. It is also satisfactory if image data processing is to be performed at a single station, whereafter the material will often leave the facility house altogether.

A recent trend has been towards having a plurality of different stations within a facilities house therefore it has been appreciated that highly powered stations, having relatively high hourly charges, may be used for specific operations where a high degree of processing power is required. However, overall charges may be reduced by performing less demanding tasks at more modest stations. However, a problem with this approach is that the data must be transferred from one station to another and the act of transferring data, with its inherent time requirement, may off-set any gains made by using less expensive stations to perform particular tasks.

As previously stated, it is known to convey video image data over internal networks but given known approaches, high bandwidth networks, such as HiPPI, are relatively expensive, which again off-sets any financial advantage made from transferring data between stations. Alternatively, it is known to convey data over TCP/IP networks but under these circumstances the rate of data transfer is relatively low, whereas the amount of data required to be transferred is usually relatively high, particularly when manipulating high bandwidth images, such as high definition TV (HDTV). Increasingly, in video facilities houses, HDTV images and images of even higher bandwidth, are being manipulated, particularly when source material is obtained by scanning cinematographic film.

Thus, in order to make best use of available hardware, it is preferable to transfer data over networks, preferably by making storage devices accessible to a plurality of stations. However, a problem arises in that known techniques will often off-set any commercial advantages gained from an ability to transfer data between stations.

### BRIEF SUMMARY OF THE INVENTION

According to an aspect of the present invention, there is provided a networked image data processing environment, comprising a plurality of image data processing systems; a plurality of data storage systems, wherein each of said data storage systems is operated under the direct control of one of said image processing systems; a high bandwidth switching means connected to each of said data processing systems; a low bandwidth network connected to said image processing systems and to said switching means, by which one of said processing systems controls the operation of said switching means and in which a first processing system requests access to a data storage system controlled by a second processing system over said low bandwidth network; said second processing system makes an identification of storage regions that may be accessed by said first processing system; said second processing system conveys said identification to said first processing system over said low bandwidth network; and said first processing system accesses said identified storage portion via said high bandwidth switching means.

### BRIEF DESCRIPTION OF THE SEVERAL VIEWS OF THE DRAWINGS

FIG. 1 shows an image data processing system;

FIG. 2 illustrates image frames of the type processed by the system shown in FIG. 1;

FIG. 3 illustrates a redundant array of inexpensive disks accessed by a fibre channel interface;

FIG. 4 illustrates a known network configuration connecting systems of the type shown in FIG. 1;

FIG. 5 shows a networked image data processing environment embodying the present invention;

FIG. 6 shows a request thread executed by a requesting processor;

FIG. 7 illustrates a data request demon executed by a supplying processor;

FIG. 8 shows an alternative network environment embodying the present invention;

FIG. 9 illustrates an off-line processing system of the type shown in FIG. 8; and

FIG. 10 illustrates a high definition image processing system of the type shown in FIG. 8.

### BEST MODE FOR CARRYING OUT THE INVENTION

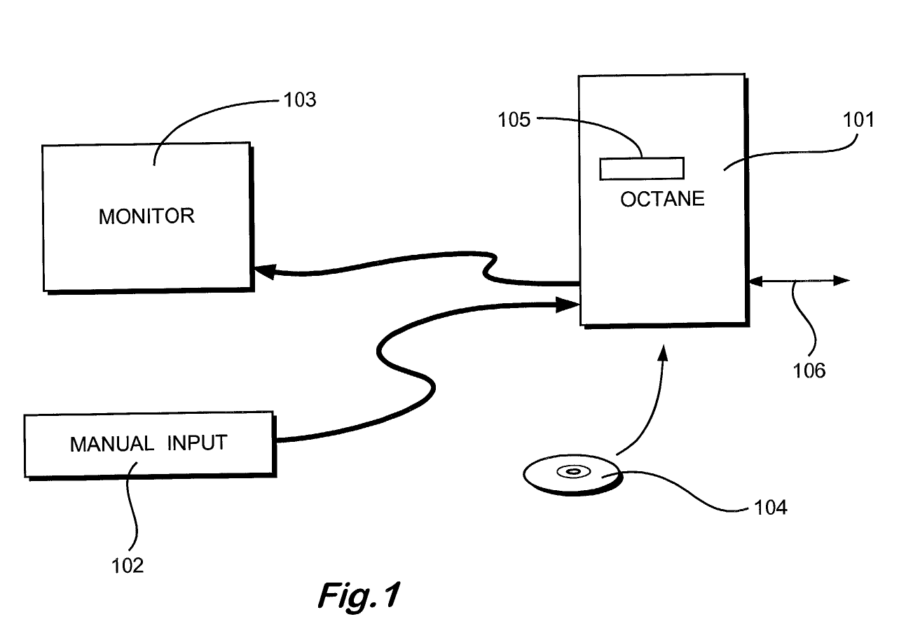

An image data processing system is illustrated in FIG. 1 consisting of a silicon graphics octane computer 101 configured to receive manual input signals from manual input devices 102 (such as a keyboard, mouse, stylus and touch tablet etc) and is arranged to supply output signals to a display monitor 103. Operating instructions are loaded into the octane computer 101, and thereafter stored on a local disk, via a data carrying medium, such as a CD ROM 104 receivable within a CD ROM reader 105. Program instructions are stored locally within the octane 101 but frames of image data are stored on a RAID (Redundant Array of Inexpensive Disks) system via a fibre channel interface 106. RAID calculations are performed by the octane 101 and data values are addressed so as to effect striping of image frames over the disk array.

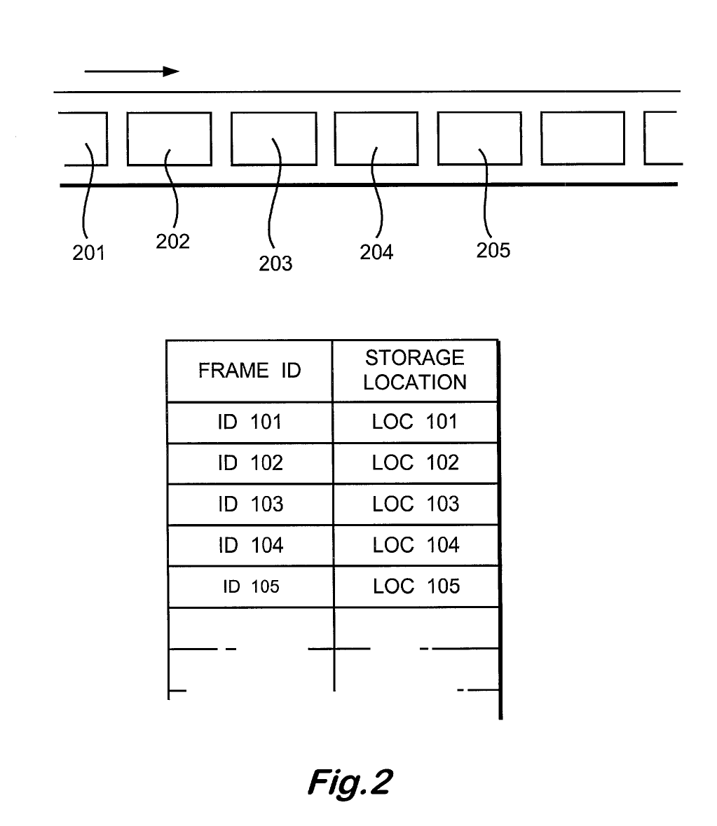

A plurality of video image frames 201, 202, 203, 204 etc are illustrated in FIG. 2. Each frame in the clip has a unique frame identification (frame ID) such that, in a system containing many clips, each frame may be uniquely identified. In a system operating with standard broadcast quality images, each frame consumes approximately one megabyte of data. Thus, by conventional computing standards, frames are relatively large therefore even on a relatively large disk array, the total number of frames that may be stored is ultimately limited. However, an advantage of this situation is that it is not necessary to establish a sophisticated directory system thereby assisting in terms of frame identification and access.

As octane 101 boots up, it mounts its associated file system and takes control of data stored at the beginning of the storage device describing object allocation for the file system in an area referred to as a superblock. The superblock describes the frames that are available within the file system and in particular maps frame ID's (identifications) to physical storage locations within the disk system. Thus, as illustrated in FIG. 2, frame ID101 is stored at location 101, frame ID102 is at location 102 and frame ID103 is at location 103 etc. Thus, if an application identifies a particular frame, it is possible for the system to convert this to a physical location within disk storage.

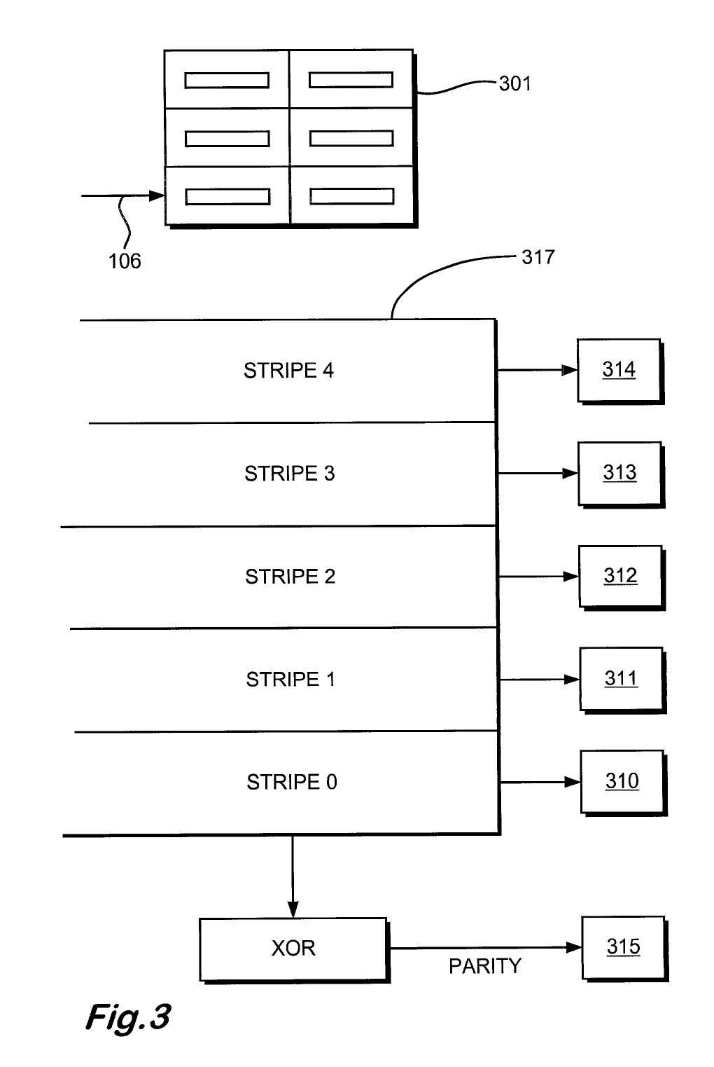

Fibre channel interface 106 communicates with a redundant array of disks 301 as illustrated in FIG. 3. The array 301 includes six physical hard disk drives, illustrated diagrammatically as drives 310, 311, 312, 313 and 314. In addition to these five disks, configured to receive image data, a sixth redundant disk 315 is provided.

An image field 317, stored in a buffer within memory, is divided into five stripes, identified as stripe zero, stripe one, stripe two, stripe three and stripe four. The addressing of data from these stripes occurs using similar address values with multiples of an off-set value applied to each individual stripe. Thus, while data is being read from stripe zero, similar address values read data from stripe one but with a unity off-set. Similarly, the same address values are used to read data from stripe two with a two unit off-set, with stripe three having a three unit off-set and stripe four having a four unit off-set. In a system having many storage devices of this type and with data being transferred between storage devices, a similar striping off-set is used on each system.

As similar data locations are being addressed within each stripe, the resulting data read from the stripes is XORd together by process 318, resulting in redundant parity data being written to the sixth drive 315. Thus, as is well known in the art, if any of disk drives 310 to 315 should fail, it is possible to reconstitute the missing data by performing a XOR operation upon the remaining data. Thus, in the configuration shown in FIG. 3, it is possible for a damaged disk to be removed, replaced by a new disk and the missing data to be re-established by the XORing process. Such a procedure for the reconstitution of data in this way is usually referred to as disk healing.

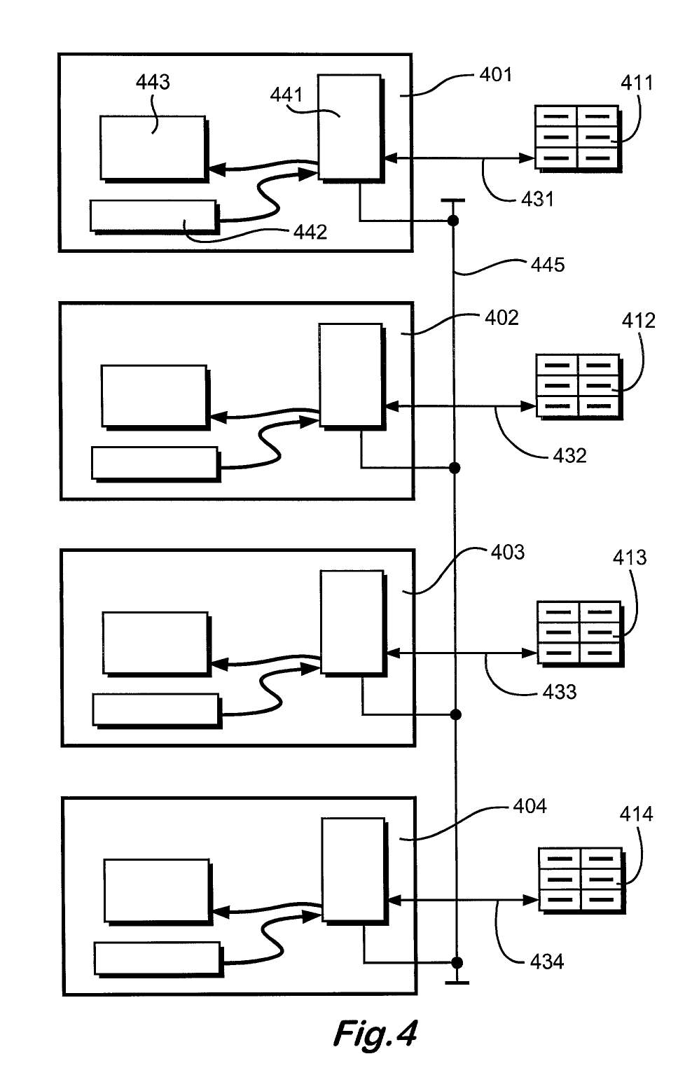

Systems of the type shown in FIG. 1 may be connected together via network configuration as shown in FIG. 4. Each image data processing system 401, 402, 403 and 404 is substantially similar to the system shown in FIG. 1. Each communicates with a respective disk array 411, 412, 413, 414 over a respective fibre channel 431, 432, 433, 434. As shown in FIG. 1, each system, such as system 401 includes an octane processor 441, input devices 442 and a monitor 443.

Each processor, such as processor 441, includes a network card to facilitate network communication over an Ethernet network 445. A program facilitating network communication remains resident on each processing system 441 enabling systems to respond to requests made from other systems. In this way, it is possible for system 401, for example, to receive image data from, for example, disk storage array 413. To achieve this, processor 441 makes a request over network 445 to the processor of system 403. A demon running on system 403 catches this request and locally determines whether it is possible for the image data to be supplied to system 401. If it is possible to supply the data, the data is read from disk storage 413 locally to system 403 and then transmitted over the Ethernet 445 to system 401. At system 401, the data may be buffered locally to storage 411 whereafter manipulations may be performed upon the data in real-time. However, it should be appreciated that the transfer of data over Ethernet 445 occurs at a rate substantially less than real-time.

It is possible to install higher bandwidth networks but these are expensive and tend not to be deployed. If a large amount of data is to be transferred, it may be preferable to store the data onto removable media, such as magnetic tape and thereafter physically transfer it to another station. However, this does require duplication of the data and procedures must be effected to ensure that the most up to date versions of material may be identified and accessed.

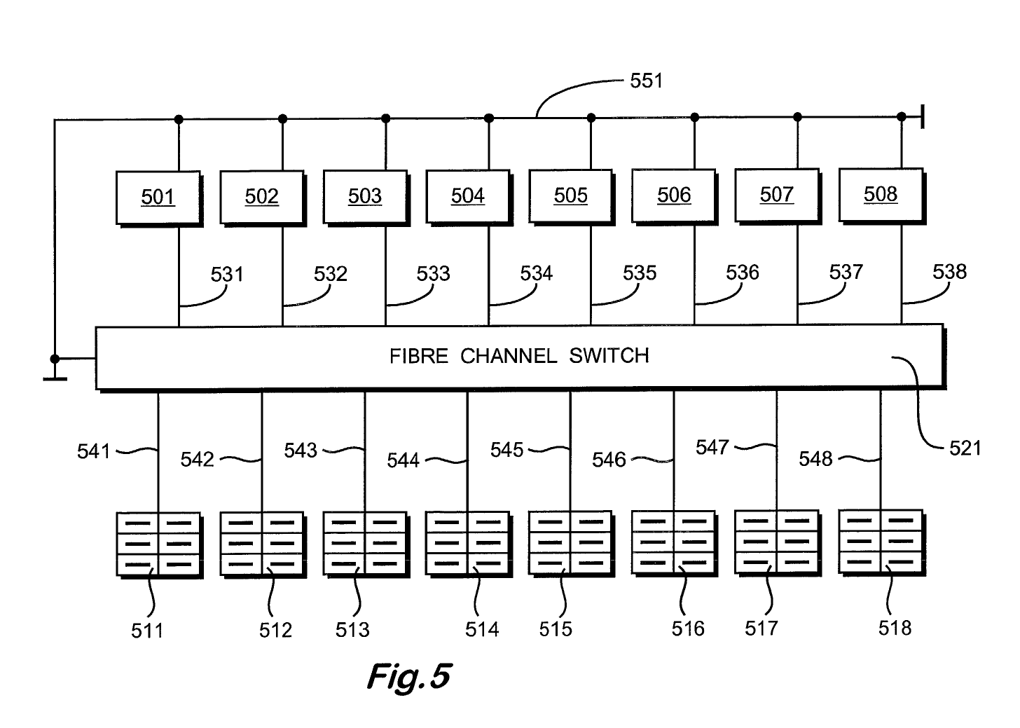

A networked image data processing environment embodying the present invention is illustrated in FIG. 5. The embodiment includes eight image data processing systems 501, 502, 503, 504, 505, 506, 507, 508 each having a respective disk array storage system 511, 512, 513, 514, 515, 516, 517 and 518. Each of the image data processing systems 501 to 508 is substantially similar to image data processing system 401 etc shown in FIG. 4. Each of the data storage systems is operated under the direct control of its respective image processing system. Thus, data storage system 511 is operated under the direct control of data processing system 501. In this respect, data processing system 501 behaves in a substantially similar manner to data processing system 401 and data storage system 511 behaves in a substantially similar manner to storage system 411. For example, each storage system 511 to 518 may be of the type obtainable from the present Assignee under the trademark “STONE” providing sixteen disks each having nine Gigabytes of storage.

The environment includes a sixteen port non-blocking fibre channel switch type 521, such as the type made available under the trademarks “VIXEL” or “ENCORE”. Switches of this type are known for providing high bandwidth access to file serving systems but in the present embodiment, the switch has been employed within the data processing environment to allow fast full bandwidth accessibility between each host processor 501 to 508 and each storage system 511 to 518. Each data processing system 501 to 508 is connected to the fibre channel switch by a respective fibre channel 531 to 538. Similarly, each storage system is connected to the fibre channel switch via a respective fibre channel 541 to 548. In addition, an Ethernet network 551, substantially similar to network 445 of FIG. 4, allows communication between the data processing systems 501 to 508 and the fibre channel switch 521.

Within the environment, a single processing system, such as system 501, is selected as channel switch master. Under these conditions, it is not necessary for all of the processing systems to be operational but the master system 501 must be operational before communication can take place through the switch. However, in most operational environments, all of the processing systems would remain operational unless taken off-line for maintenance or upgrade etc. Master processor 501 communicates with the fibre channel switch 521 over the Ethernet network 551. Commands issued by processor 501 to the fibre channel switch define physical switch connections between processing systems and the disk storage arrays 511 to 518.

On start-up, the switch 521 is placed in a default condition to the effect that each processor is connected through the switch 521 to its respective storage system. Thus, on booting up processing system 502, for example, it mounts its own respective storage system 512 and takes control of the superblock defining the position of images held on that storage system, as illustrated in FIG. 2. Thus, each processing system 501 to 508 takes control of its respective data storage system such that each storage system 511 to 518 runs under the control of its respective host. Thus, another processing system, such as system 507, may only gain access to storage system 512 if it is allowed to do so by its host data processing system 502.

It is not possible for data processing system 507 to mount the superblock of storage system 512 or any of the other storage systems with the exception of its own storage system 517. In theory, this could be possible but the procedures operated by the data processing systems are configured so as to prevent this, thereby maintaining data integrity.

A request to gain access to an alternative data storage system is made over Ethernet connection 511. Again, a demon runs on each of the processing systems in order to respond to these requests and the procedures formed are substantially similar to the procedures executed by the environment described with respect to FIG. 4. Thus, data processing system 507 may issue a request over Ethernet 551 to data processing system 502 to the effect that processor 507 requires access to storage system 512, that is primarily under control of data processing system 502.

Within the previous environment, processes executed by data processing system 502 and system 507 could effect a direct memory access to processing system 507 over Ethernet 551 but, as previously stated, this would not occur in real-time (that is, at video display rate). However, in the present embodiment, once it has been established that processor 507 may modify particular frames stored on storage system 502, processor 502 makes a request to control processor 501 which in turn effects a modification to the fibre channel switch 521. The non-blocking switch 521 provides a full bandwidth fibre channel between fibre channel interface 542 and fibre channel interface 537.

By providing full bandwidth access to the storage system of other hosts, substantial advantages are gained in terms of a reduction of data copying and transfer and an ability to process data stored elsewhere in a fashion similar to the processing of local data. Thus, with full bandwidth access provided by the fibre channel switch 521, it is possible to perform real-time effects, previously only implemented using local storage, while accessing remote data again providing significant time savings and storage optimisations.

An example has been described in which processor 507, a host to storage system 517, requests frames of data from storage system 512, hosted by processing system 502. Processing system 502 retains control of storage system 512 therefore in order for processing system 507 to gain access to storage system 502, it is necessary for procedures to be executed, in the form of a request thread, on processor 507 and for procedures, in the form of a response demon, to be executed on processor 502.

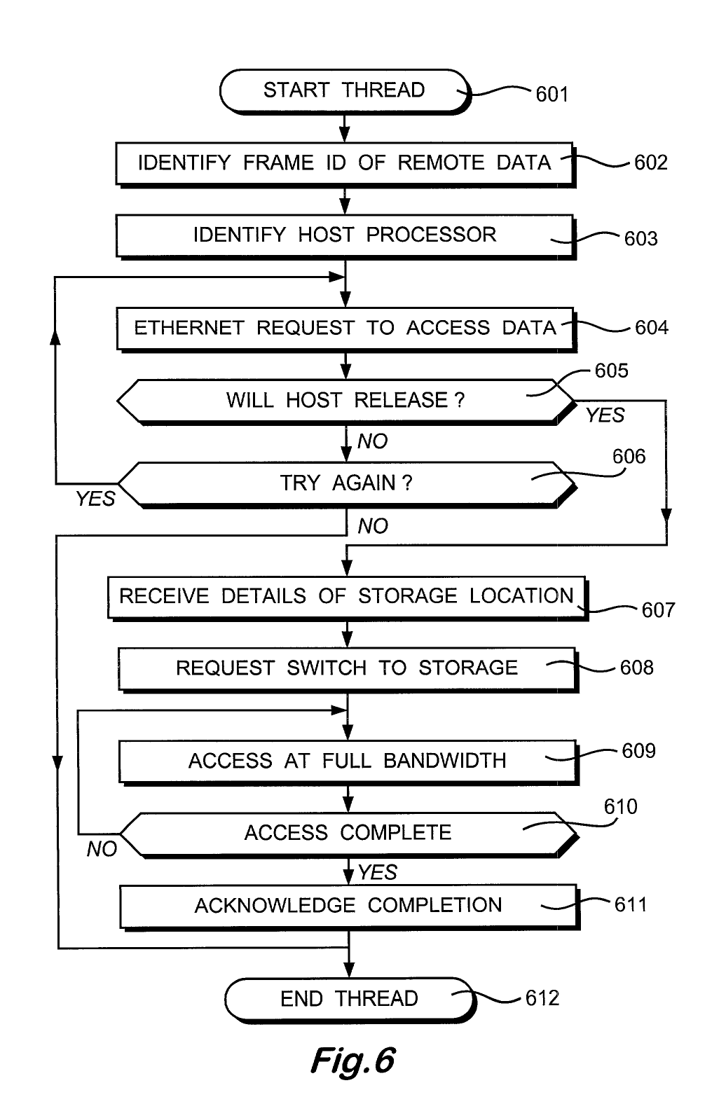

A request thread, executed by processor 507 in the example but generally executable by all processors in the environment, is detailed in FIG. 6. A thread is initiated at step 601 whereafter at step 602 a frame identification for the remote data required is identified. Thereafter, at step 603 the host processor responsible for this data is identified which, in this example, is host processor 502.

At step 604 a request is made by host processor 507 over Ethernet connection 551 to host processor 502. This request includes data receivable by processor 502 to the effect that host processor 507 requires access to specific frames held on storage system 512.

In response to this request, host processor 502 may allow processor 507 to access storage system 512 through the fibre channel switch 521. Alternatively, processor 502 may require full bandwidth access to storage system 512 itself and under these circumstances it may refuse to give processor 507 access to its storage system. Thus, at processor 507 a question is asked as to whether the remote host (502 in this example) will release access to its disk system (system 512 in this example). If the question is answered in the negative, a question is asked at step 606 as to whether a further request is to be made in an attempt to gain access and if this is answered in the affirmative, control is returned to step 604. The system would be programmed to make several attempts and the actual number of attempts made before no further attempts are made is a detail of implementation. If it is decided that no further attempts will be made, control is directed to step 612 where the thread ends.

If the remote host processor is prepared to give access to its disk storage system, the question asked at step 605 will be answered in the affirmative and control will be directed to step 607.

The requesting processor 507 supplies a frame identification or identifications for a plurality of frames making up a continuous clip. Thus, for example, processor 507 may submit a request to processor 502, over Ethernet connection 551, to the effect that it requires access to frames with frame ID's ID101 to ID105, as shown in FIG. 2. Host processor 502 then consults the superblock of its mounted storage system 512 to determine that frame ID101 is at location LOC101, and so on until frame identification ID105 which is located at location LOC105. This information is then returned back to the requesting processor 507, as shown at step 607 to the effect that details of the storage location have been received.

At step 607 processor 507 issues a request to the effect that a storage switchover is required. This request is made via control processor 501 which in turn issues a command to fibre channel switch 521 resulting in a disconnection of storage system 512 to processing system 502 and a connection of storage system 542 to the requesting host processing system 507. With this connection in place, processing system 507 theoretically has full access at full bandwidth to storage system 512. However, instructions executed by processing system 507 are such that, although processing system 507 has full bandwidth access to storage system 512, it is only permitted to modify frames that constitute part of the original request. Thus, processing system 507 may access locations LOC101, LOC102, LOC103, LOC104 and LOC105 in this particular example but it is not permitted to access any other positions within disk storage system 512.

At step 610 a question is asked as to whether the access has completed and if answered in the negative control is returned to step 609 thereby permitting further access at full bandwidth. Various tests may be included within step 610 to determine when the transfer should be completed. Preferably, full bandwidth access to storage systems should be returned to their host processors as soon as possible and only switched over to other processors when specific data transfers are required.

When the question asked at step 610 is answered in the affirmative, an acknowledgement of completion is issued by processor 507 to processor 502 and processor 501 at step 611, resulting in switch 521 being activated to reconnect storage system 512 with its host processor 502 and also instructing processor 502 to the effect that the switchover has taken place. Consequently, processing system 502 may now take full control of its associated disk storage system 512. Thereafter, the thread ends at step 612.

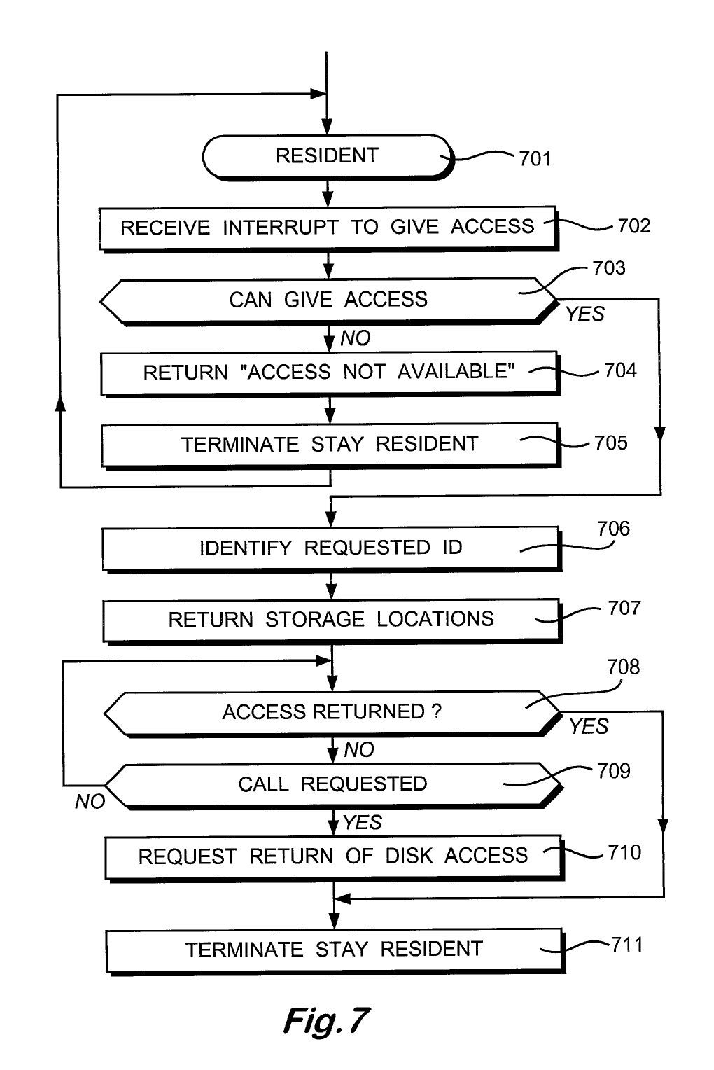

The data request demon executed by each of the processing systems 501 to 508 is detailed in FIG. 7. As is known with technology of this type, the program remains resident but not executing until called upon to do so by an external request. The residency of the thread is illustrated by step 701.

The process is initiated at step 702 upon receiving an interrupt to the effect that a data access is required. At step 703 a question is asked as to whether access can be given and if answered in the negative, an instruction to the effect that access is not available is returned to the requesting processor over Ethernet 551. Thus, following the previous example, processor 502 will deny access to processor 507 if processor 502 requires full bandwidth access to its own local storage system 512. Alternatively, if full bandwidth access is not required, it may be possible to allow the requesting processor (processor 507) to gain access through the fibre channel switch 521. If access is not available, the thread terminates and stays resident at step 705 returning it to the resident state 701.

If access can be given the question asked at step 703 is answered in the affirmative and control is directed to step 706. The requesting host generates a frame identification and the requested identification is identified at step 706. The processor then makes reference to its superblock allowing it to return details of storage locations at step 707.

After returning the storage locations, the host processor effectively hands over access to its local disk storage system. The philosophy of procedures executed by the host system is that other hosts should not be allowed access for long. Consequently, at step 708 a question is asked as to whether access has been returned, implemented by a completion acknowledgement generated at step 611. If access has not been returned, the question asked at step 708 is answered in the negative and a question is asked at step 709 as to whether a call should be made to actively request return of the access. If this question is answered in the negative, control is returned to step 708.

If the local processor determines that another host processor has retained access for too long, resulting in the question asked at step 709 being answered in the affirmative, a request is issued at step 710 for the return of disk access. This should then result in access being returned whereafter the demon may terminate and stay resident.

Ideally, host processors should allow other processors access for periods allowing them to do useful work therefore under ideal conditions access should be returned before the host processor demands it, resulting in the question asked at step 708 being answered in the affirmative. This results in control being returned to the local processor and again the thread terminates at step 711.

In the network environment shown in FIG. 5, all of the processing systems 501 to 508 are substantially similar and are implemented on the Silicon Graphics Octane plafform. Manipulations upon image data, using software applications such “FLAME” and “FIRE” licensed by the present Assignee, may be executed to perform manipulations upon standard bandwidth video material. However, in many environments, higher bandwidth images are processed, such as those for high definition television or for those generated by scanning cinematographic film. Similarly, stations of lower capability are also provided, possibly for manipulating lower bandwidth material, off-line editing or for performing simple manipulations upon data, possibly loading data into the environment from video tape.

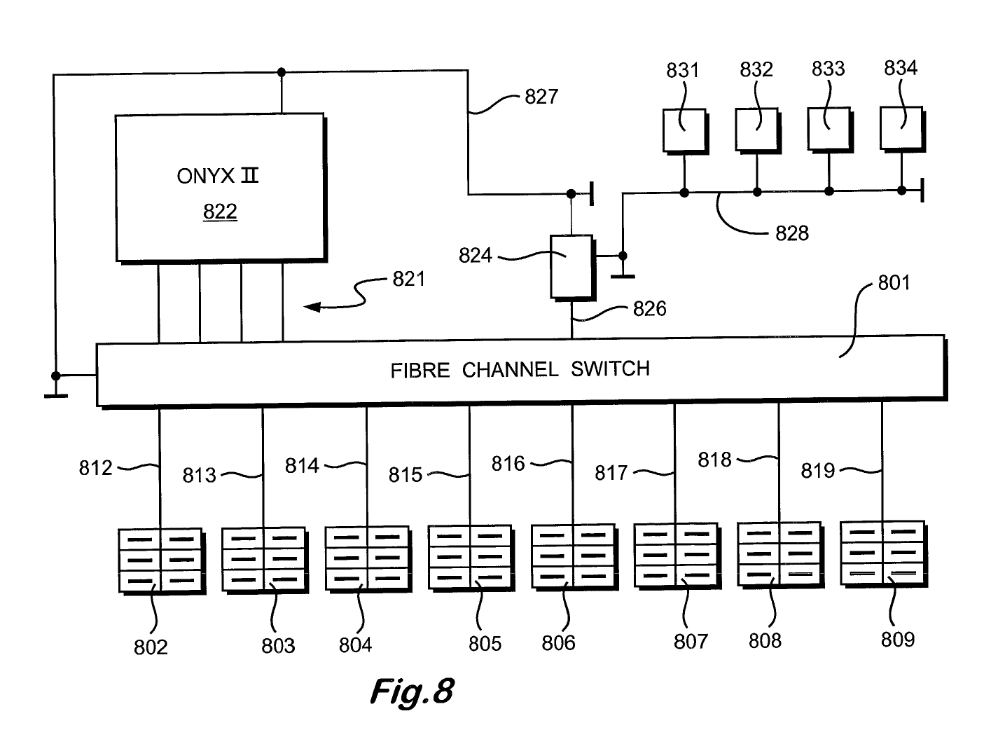

An alternative environment is illustrated in FIG. 8. Fibre channel switch 801 is substantially similar to switch 521 and storage system 802 to 809 are substantially similar to systems 511 to 518.

Storage systems 802 to 809 are connected to fibre channel switch 801 over respective fibre channel interfaces 812 to 819. These are substantially similar to interfaces 541 to 548 and result in a further eight interface nodes being available on switch for communication to processing systems. Four interface nodes of the fibre channel switch 801 are connected by interfaces 821 to a Silicon Graphics Onyx2 computer 822. These four fibre channel communications are connected, by default, to storage system 802 to 805. This provides full bandwidth transfer of high definition television signals between storage and the Onyx2 computer or it provides several full bandwidth channels of lower definition signals, such as standard broadcast video. This represents top-end image processing capability but, as such, would incur substantial time charges within a facilities house.

In known environments employing top-end equipment, it is known that time may be taken on the equipment merely to load source material into the environment or to download completed material from the environment. Under these circumstances, many of the capabilities of the top-end facility effectively becomes redundant and is thereby a substantial overhead.

In the environment shown in FIG. 8, Onyx2 computer 822 acts as switch master and as such allows the Onyx2 to perform a reconnection such that interfaces 821 are connected to storage systems 806 to 809 instead of being connected to storage systems 802 to 805. An advantage of performing a switchover of this type is that while the Onyx2 computer 822 is performing top-end operations using data stored in storage systems 802 to 805, data may be removed from storage systems 806 to 809 and new material may be loaded to these storage systems. Eventually, a particular job will complete and finished material will reside on storage systems 802 to 805. It is now necessary to remove the data from these storage systems but this is a relatively lowly task to be performed on the Onyx computer. Consequently, a switchover occurs such that the Onyx2 computer may now manipulate material stored on systems 806 to 809. The transfer of completed data from storage systems 802 to 805 and its replacement with new source material is performed by an alternative system.

In addition to Onyx2 computer 822, an octane-based system 824 is connected to the fibre channel switch 801 via an interface 826. Onyx system 822 and octane system 824 communicate with the fibre channel switch 801 over an Ethernet network 827. Octane system 824 is substantially similar to the data processing system shown in FIG. 5, with the addition of a second Ethernet network 828. This in turn has four off-line systems 831, 832, 833 and 834 connected thereto. The off-line systems are primarily configured to facilitate the loading of video information such that this loaded information may then be manipulated by the Onyx2 system in real-time. In addition, modest housekeeping manipulations may be performed by systems 831 to 834 and these systems may also be configured to perform off-line editing procedures upon compressed representations of video frames.

Thus, in the environment shown in FIG. 8, any of systems 824, 831 to 834 may be involved with the transfer of data to the storage systems 802 to 809. In a preferred arrangement, the Onyx2 system 822 remains almost constantly in operation and is given access to sub-set 802 to 805 of the storage systems or to sub-set 806 to 809 of the storage systems. When using storage systems 802 to 805, storage systems 806 to 809 may be accessed by the secondary system 824 or by the tertiary systems 831 to 834. Off-line station 831 may be allocated the task of ensuring that the Onyx2 system 822 is kept busy such that while working on a sub-set of disks an offline operator at station 831 must ensure that data is maintained in the complimentary sub-set of disks. In this way, a handover may occur whereafter the off-line operation at station 831 would be responsible for releasing process data and the loading of new data to ensure that a further handover could take place and so on thereby optimising availability of the Onyx2 system.

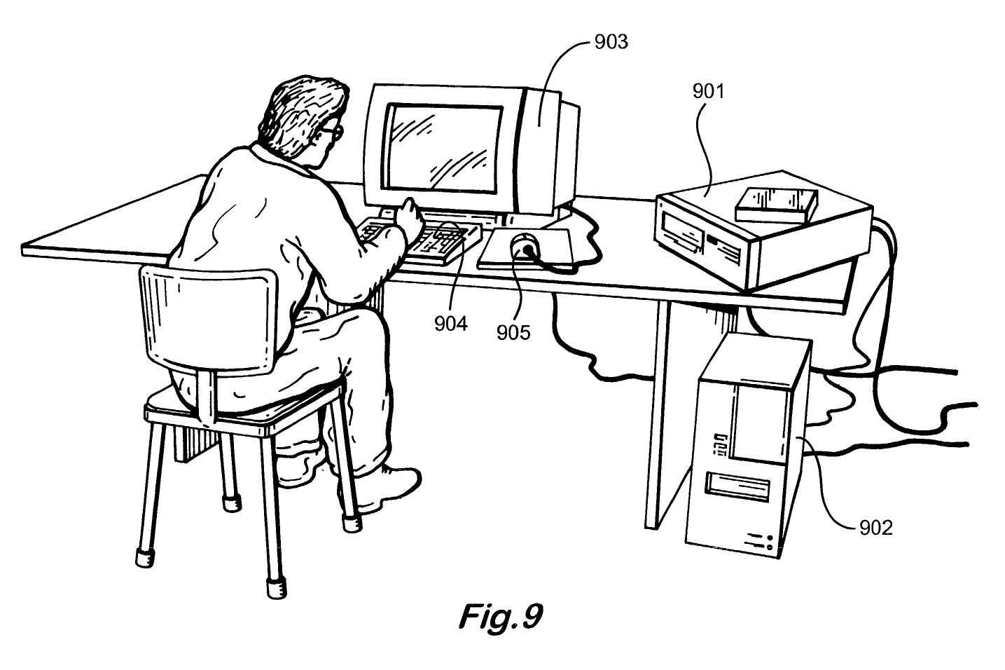

Off-line processing system 831 is detailed in FIG. 9. New input material is loaded via a high definition video recorder 901. Operation of recorder 901 is controlled by a computer system 902, possibly based around a personal computer (PC) platform. In addition to facilitating the loading of high definition images to storage systems, processor 902 may also be configured to generate proxy images, allowing video clips to be displayed via a monitor 903. Off-line editing manipulations may be performed using these proxy images, along with other basic editing operations. An off-line editor controls operations via manual input devices including a keyboard 904 and mouse 905.

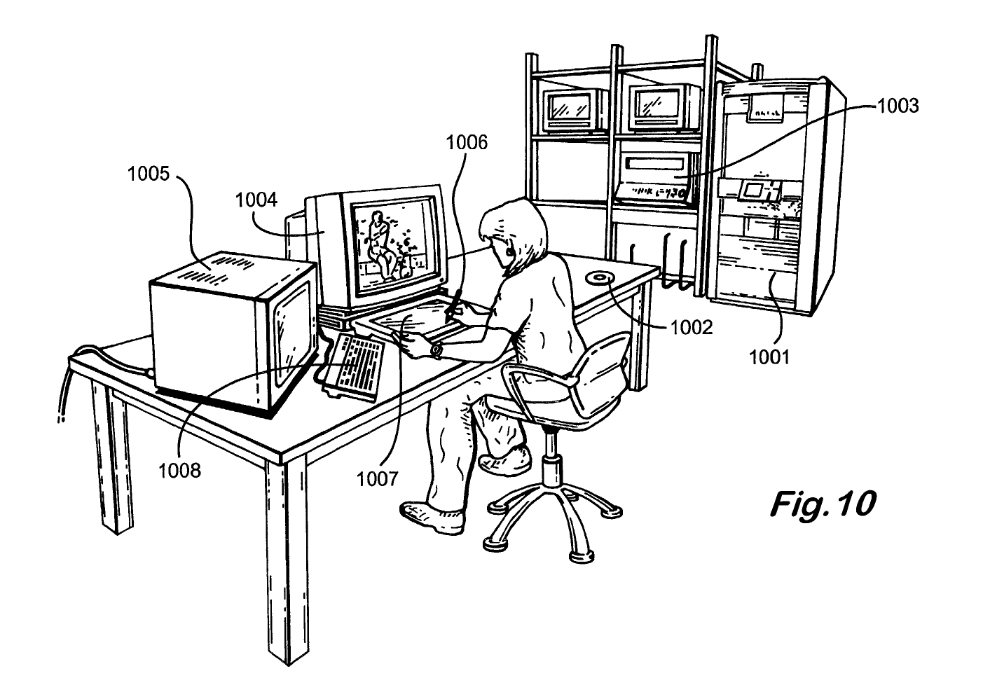

Data processing system 822 is illustrated in FIG. 10, based around an Onyx2 computer 1001. Program instructions executable within the Onyx2 computer 1001 may be supplied to said computer via a data carrying medium, such as a CD ROM 1002.

Image data may be loaded locally and recorded locally via a local digital video tape recorder 1003 but preferably the transferring of data of this type is performed off-line, using stations 831 to 834 etc.

An on-line editor is provided with a visual display unit 1004 and a high quality broadcast quality monitor 1005. Input commands are generated via a stylus 1006 applied to a touch table 1007 and input commands may also be generated via a keyboard 1008.

The environment described herein allows a plurality of disk storage systems to be accessed by a plurality of host processors at full bandwidth. Furthermore, the procedures for effecting a handover via a full bandwidth switch ensure that the integrity of data contained within the system is maintained. In particular, a host processor retains control of a particular disk system and requests must be made to the host processor in order for a remote processor to gain access thereto.

1. A networked image data processing environment, comprising a plurality of image data processing systems;
a plurality of data storage systems, wherein each of said data storage systems is operated under the direct control of one of said image processing systems;
a high bandwidth switching means connected to each of said data processing systems;
a low bandwidth network connecting said image processing systems and to said switching means, by which one of said processing systems controls the operation of said switching means, and in which
a first processing system requests access to a data storage system controlled by a second processing system over said low bandwidth network;
said second processing system makes an identification of storage regions that may be accessed by said first processing system and to each of said storage systems;
said second processing system conveys said identification to said first processing system over said low bandwidth network; and
said first processing system accesses said identified storage portion via said high bandwidth switching means.

2. A processing environment according to claim 1, wherein said data processing systems are based around a silicon graphics O₂, Octane or Onyx2 computer.

3. A data processing environment according to claim 1, wherein said data storage systems include a plurality of disks configured to receive image stripes.

4. A data processing environment according to claim 3, including redundant disks to provide data security.

5. A data processing environment according to claim 4, wherein said disks are configured as a redundant array of inexpensive disks (RAID).

6. A data processing environment according to claim 1, wherein said high bandwidth switching means is a fibre channel switch.

7. A data processing environment according to claim 1, wherein said low bandwidth network is an Ethernet network.

8. A data processing environment according to claim 1, wherein said processing systems execute programs to identify requests made by other processing systems.

9. A data processing environment according to claim 1, wherein at least one image data processing system has direct control of a plurality of data storage systems.

10. A data processing environment according to claim 9, including lower powered data processing systems that are configured to supply image data to image data processing systems connected to said high bandwidth switching means.

11. A method of transferring data in a networked image data processing environment, including a plurality of image data processing systems, a plurality of data storage systems, a high bandwidth switching means connected to each of said data processing systems and to each of said storage systems, and a low bandwidth network connected to said image processing systems and to said switching means, by which one of said processing systems controls the operation of said switching means, wherein said method performs the steps of:
operating each of said data storage systems under the direct control of one of said image processing systems;
issuing a request from a first processing system to access a data storage system controlled by said second processing system over said low bandwidth network;
making an identification at said second processing system of storage regions that may be accessed by said first processing system;
conveying said identification from said second processing system to said first processing system over said low bandwidth network; and
accessing said identified storage portion by said first processing system via said high bandwidth switching means.

12. A method according to claim 11, wherein said data processing systems are based upon a Silicon Graphics O₂, Octane or Onyx2 computer.

13. A data processing environment according to claim 11, wherein said data storage system includes a plurality of disks configured to receive image stripes.

14. A method according to claim 13, including redundant disks to provide data security.

15. A method according to claim 14, wherein said processing systems are configured to write data to said array of disks and read data from said array of disks using RAID protocols.

16. A method according to claim 11, wherein said high bandwidth switching means is a fibre channel switch.

17. A method according to claim 11, wherein said low bandwidth network is an Ethernet network.

18. A method according to claim 11, wherein said processing systems execute programs to identify requests made by other processing systems.

19. A method according to claim 11, wherein at least one image processing system has direct control of a plurality of data storage systems.

20. A method according to claim 19, including lower powered data processing systems that are configured to supply image data to image data processing systems connected to said high bandwidth switching means.

21. A computer-readable medium having computer-readable instructions executable by a computer such that, when executing said instructions, a computer will perform the steps of
directly controlling a local disk storage system;
issuing a request to access a data storage system controlled by a second processing system over a low bandwidth network;
receiving an indication from said remote processing system identifying storage locations that may be accessed on said second storage system;
accessing said data portions through a high bandwidth switching means connected to each of said processing systems and to each of said storage systems.

22. A computer-readable medium having computer-readable instructions according to claim 21, such that when executing said instructions a computer will perform RAID calculations when writing data to a locally controlled disk and when reading data from said locally controlled disk.

23. A computer-readable medium having computer-readable instructions according to claim 21, such that when executing said instructions a computer will issue said requests over an Ethernet network.

24. A computer-readable medium having computer-readable instructions according to claim 23, such that when executing said instructions a computer will receive said indication over said Ethernet network.

25. A computer-readable medium having computer-readable instructions according to claim 21, such that when executing said instructions a computer will access said indicated portions through a fibre channel switch.

26. A computer-readable medium having computer-readable instructions executable by a computer such that, when executing said instructions, a computer will perform the steps of
directly controlling a local disk storage system;
responding to a request from a remote data processing system to access said local disk storage system;
identify a portion of said local disk processing system that may be accessed by said remote processing system; and
issuing an indication to the effect that said remote processing system may gain access to said storage system via a high bandwidth switching means.

27. A computer-readable medium having computer-readable instructions according to claim 26, such that when executing said instructions, a computer will respond to said requests received over a low bandwidth Ethernet.

28. A computer-readable medium having computer-readable instructions according to claim 27, such that when executing said instructions a computer will issue said indication over said low bandwidth Ethernet.

29. A computer-readable medium having computer-readable instructions according to claim 26, such that when executing said instructions a computer will perform RAID calculations while directly controlling said local disk storage systems.

30. A computer-readable medium having computer-readable instructions according to claim 26, such that when executing said instructions a computer will issue an indication to the effect that said remote processing systems may gain access to said storage systems via a fibre channel switch.
